(19) United States
(12) Patent Application Publication
(10) Pub. No.: US 2009/0328210 A1
(43) Pub. Date: Dec. 31, 2009

(54) CHAIN OF EVENTS TRACKING WITH DATA TAINTING FOR AUTOMATED SECURITY FEEDBACK

(75) Inventors: Vassilii Khachaturov, Lehavim (IL); Vladimir Holostov, Hadera (IL); John Neystadt, Kfar Saba (IL)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/165,608

(22) Filed: Jun. 30, 2008

(51) Int. Cl. G06F 21/00

(52) U.S. Cl. 726/22

(57) ABSTRACT

An automated security feedback arrangement is provided by which a specialized audit record called a tainting record is linked to data crossing the perimeter of a corpnet that comes from potentially untrusted sources. The linked tainting record operates to taint such data which may be received from external sources such as e-mail and websites or which may comprise data that is imported into the corpnet from mobile computing devices. Data that is derived from the original data is also tainted using a linked tainting record which includes a pointer back to the previous tainting record. The linking and pointing back are repeated for all subsequent derivations of data to thus create an audit trail that may be used to reconstruct the chain of events between the original data crossing the perimeter and any security compromise that may later be detected in the corpnet.

### BACKGROUND

Public networks such as the Internet are commonly used to allow businesses and consumers to access and share information from a variety of sources. However, security is often a concern when accessing the Internet. Particularly for businesses, which often allow Internet conductivity to their private corporate networks (“corpnets”), there is a threat of malicious software being downloaded from a website which may contain viruses, Trojan horses, or other malicious executable code (collectively referred to as “malware”) that may infect computers inside the private network. To prevent such infections, network administrators often employ “anti-X” technologies (where “X” is typically used to denote “virus,” “spyware,” “malware,” etc.) at the enterprise level.

While anti-X technologies may perform satisfactorily in some settings, they generally cannot cope with data that is arbitrarily tunneled, obfuscated, or hidden by steganographic techniques that are intended to conceal the data within other files and which often may appear to the user to be legitimate and/or harmless. For example, some malware code can be obfuscated, or passed in source form and compiled by the user according to social engineering instructions from a malicious attacker where user interaction with the code executes the attack.

Detecting each and every piece of steganographic data at an edge device, such as a firewall deployed at the perimeter of the corpnet, is theoretically impossible. In addition, with mobile computing and storage devices connecting in and out of the corpnet, even if perfect edge protection were available, it would not apply when a PC (personal computer) or other device is connected to a less secure network outside of the protected perimeter of the corpnet. However, when at some later stage a security compromise does occur and is detected within the network perimeter (for example by an anti-virus agent running on the desktop), it would be desirable to know exactly which weaknesses in the protection software and/or users' interactions and behaviors led to the compromise in order to prevent similar compromises from occurring in the future.

This Background is provided to introduce a brief context for the Summary and Detailed Description that follow. This Background is not intended to be an aid in determining the scope of the claimed subject matter nor be viewed as limiting the claimed subject matter to implementations that solve any or all of the disadvantages or problems presented above.

### SUMMARY

An automated security feedback arrangement is provided by which a specialized audit record called a tainting record is linked to data crossing the perimeter of a corpnet that comes from potentially untrusted sources. The linked tainting record operates to taint such data which may be received from external sources such as e-mail and websites or which may comprise data that is imported into the corpnet from mobile computing devices such as laptop computers, mobile phones, and portable mass storage devices. Data that is derived from the original data is also tainted using a linked tainting record which includes a pointer back to the previous tainting record. The linking and pointing back are repeated for all subsequent derivations of data to thus create an audit trail that may be tracked and used to reconstruct the chain of events between the original data crossing the corpnet perimeter and any security compromise such as a virus or other malware infecting a workstation that may later be detected in the corpnet.

Enterprise-wide collection of chains of events for all security compromises may be performed using, for example either a centralized or virtual audit server, to discover common patterns of user behavior which lead to such compromises and may be used as feedback to improve security in the corpnet. Such feedback may be automated in the form of alerts to the corpnet perimeter that may be used to block certain traffic or to establish edge protection rule sets. The feedback may also be used as an educational tool to present back to the users the chains of events leading to security compromises, and expose repetitive negligent user behaviors, to teach and inform the users of better security practices.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### DESCRIPTION OF THE DRAWINGS

FIG. 1 shows an illustrative computing environment in which the present chain of events tracking may be practiced;

FIG. 2 shows an illustrative generalized data flow through the corpnet where tainting records are linked to incoming data and derived data to taint the data and generate an audit trail that may be used to reconstruct a chain of events between a security compromise and the incoming data;

FIG. 3 shows a first illustrative chain of events;

FIG. 4 shows a second illustrative chain of events;

FIG. 5 shows an illustrative arrangement by which security feedback may comprise automated and/or manual processes;

FIG. 6 shows an illustrative automated security feedback process;

FIG. 7 shows an illustrative manual security feedback process that involves exposure of chains of events;

FIGS. 8, 9, and 10 show illustrative e-mail messages that are utilized to provide educative feedback to users which expose chains of events to highlight repetitive negligent user behaviors; and

FIG. 11 shows an illustrative manual security feedback process that involves publication of an educating digest that focuses on key wrong decisions in a chain of events that leads to a security compromise.

Like reference numerals indicate like elements in the drawings. Elements are not drawn to scale unless otherwise indicated.

### DETAILED DESCRIPTION

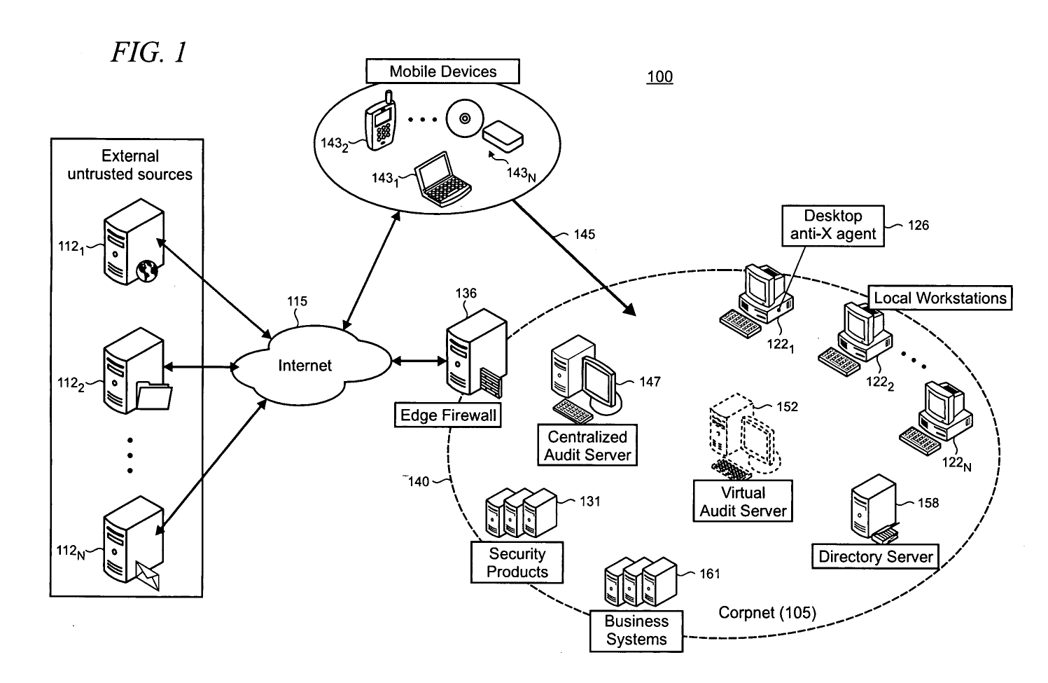

FIG. 1 shows an illustrative computing environment 100 in which the present chain of events tracking may be practiced. A corpnet 105 is coupled to a variety of external untrusted sources 1121, 2 . . . N over a public network such as the Internet 115. The untrusted sources include, in this example, illustrative websites 1121, external file servers and/or databases 1122, and e-mail 112N. However, it is emphasized that any of a variety of different untrusted sources may be accessed by users in the corpnet 105 depending on the circumstances applicable to a particular implementation. Accordingly, such untrusted sources may vary from those shown in FIG. 1.

A plurality of workstations 122_{1, 2 . . . N} such as PCs, laptops, and other host devices will typically be deployed in the corpnet 105. Each workstation 122 will generally be configured with a desktop agent, as representatively indicated by reference numeral 126 which provides anti-X capabilities. These capabilities may be supplemented or, in some cases, replaced by security functionalities that may be provided by various types of security products 131 that may be present in the corpnet 105. Such security products may include, for example, a host-protection security product, network intrusion detection system (“NIDS”), a network access protection (“NAP”) security product, security event management/security incident management security products (“SEM”/“SIM”), and the like.

An edge firewall 136 is positioned at the network perimeter 140 of the corpnet 105 which protects the corpnet 105 from Internet-based threats. Typically, the firewall 136 will monitor inbound and outbound traffic between the Internet 115 and the corpnet 105. Firewall security is often enforced through filtering according to a rule set or other policies. Filtering can be performed on a packet basis at the network and transport layers of the seven-layer OSI (Open System Interconnection) model, using stateful filtering where information about a TCP (Transport Control Protocol) session is utilized to determine if a packet is allowed or denied, or using application-layer filtering in which intelligent filtering is performed based on packet contents. In some implementations, the edge firewall 136 may be embodied, for example, as a Microsoft Internet Security and Acceleration® (“ISA”) server that incorporates in-memory and disk-based caching functionality to improve the speed at which web data is served to the workstations 122. Mobile devices 143 are also supported in the present computing environment 100. Such devices 143 are commonly used by enterprise users while they are away from the physical corpnet 105 when, for example, working from home or while away on travel. A variety of different types of mobile devices may be used in a given implementation as representatively illustrated by a laptop computer 143₁, a smart phone 143₂, and portable storage media 143_{N} which include, for example, optical discs, and mass storage devices such as portable hard disk drives and flash-based devices like USB (Universal Serial Bus) flash devices.

A user may connect a mobile device 143 to resources from the external untrusted sources 112 via the Internet 115 when the user and the device are outside the corpnet 105. The user may then bring the mobile device 143 inside the perimeter 140 of the network 105 which presents another pathway for potential malware to be introduced into the corpnet 105 as indicated by arrow 145. While the edge firewall 136 may often provide very satisfactory results in minimizing the introduction of Internet-based threats into the corpnet 105, it is noted that even perfect edge protection would not normally be applicable to this pathway that the mobile devices 143 enable to the corpnet.

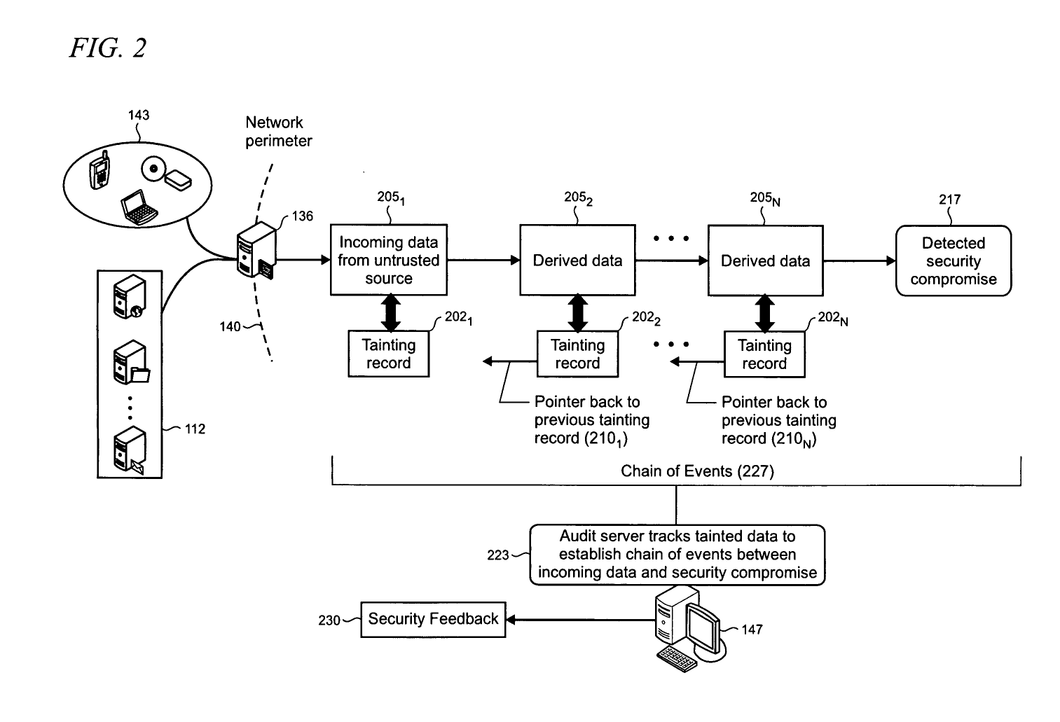

A centralized audit server 147 is also deployed in the corpnet 105. In addition to providing conventional auditing functions, the centralized audit server 147 is utilized here to collect and record chains of events on an enterprise-wide basis in the corpnet 105, as described in more detail below in the text accompanying FIG. 2.

In alternative implementations, the features and functionalities provided by the centralized audit server 147 may be provided using a virtual audit server 152 that is distributed among the other platforms in the corpnet 105. In this case, a thin software layer is typically run on each workstation 122 which presents an abstraction of virtual machines to the other workstations to enable the auditing functionality to be virtualized. In addition, the virtualization enables the software on a given workstation to be strongly isolated. Software on one virtual machine cannot see or affect another virtual machine unless explicitly permitted by the virtual audit server 152. This virtualization feature provides a measure of resilience against malware tampering with the audit data.

A directory server 158 is also utilized in the corpnet 105. The directory server 158 provides support to manage user identities including, for example, authentication and authorization services for the users working at the local workstations 122. Other business systems 161, including accounting systems for example, may also be commonly deployed in the corpnet 105.

Turning now to FIG. 2, an illustrative generalized data flow through the corpnet 105 is shown. In this example, a specialized audit record referred to here as a tainting record 202₁ is linked (i.e., associated) to incoming data 205₁ coming across the network perimeter 140 from an untrusted source 112 to thereby taint it. Any data 205_{2 . . . N} that is derived from the original incoming data 205₁ is also tainted using a respective linked tainting record 202_{2 . . . N}, as shown. The granularity of the audit that is implemented by the tainting, for example at a file level, disk partition level, etc., may be configured as needed to suit a particular implementation.

Each subsequent tainting record 202_{2 . . .} N that follows the original tainting record 202₁ includes a pointer 210_{1 . . . N} that points back to the previous tainting record. The linking of the tainting records to derived data and the pointing back to the previous tainting record may thus create an audit trail that is tracked by the audit server 147 and used to reconstruct a chain of events between the original data 205₁ crossing the corpnet perimeter 140 and any security compromise 217 such as a virus or other malware infecting a workstation 122 that may be later detected in the corpnet 105. The security compromise 217 in the corpnet 105 may be detected, for example by a desktop agent 126 or by a security product 131 operating in the corpnet.

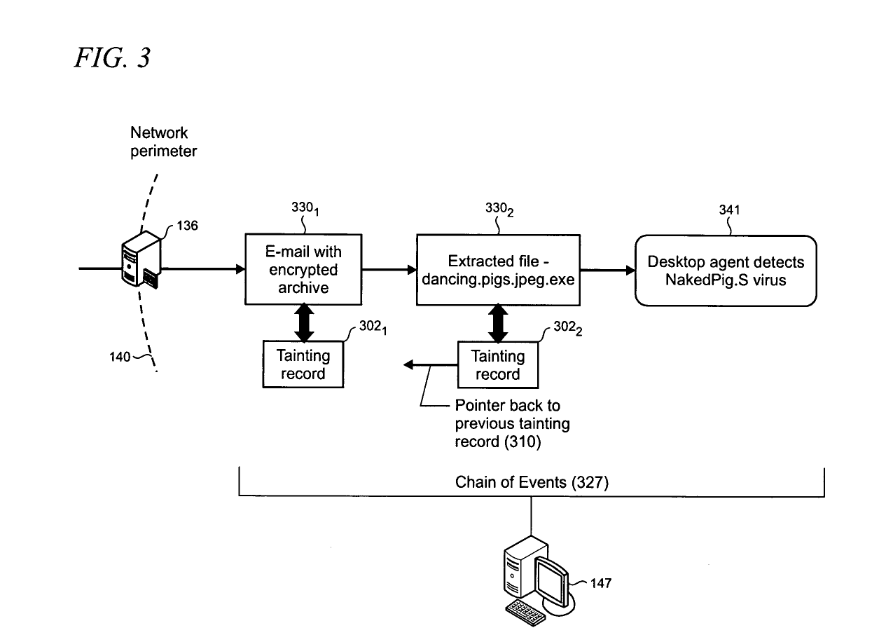

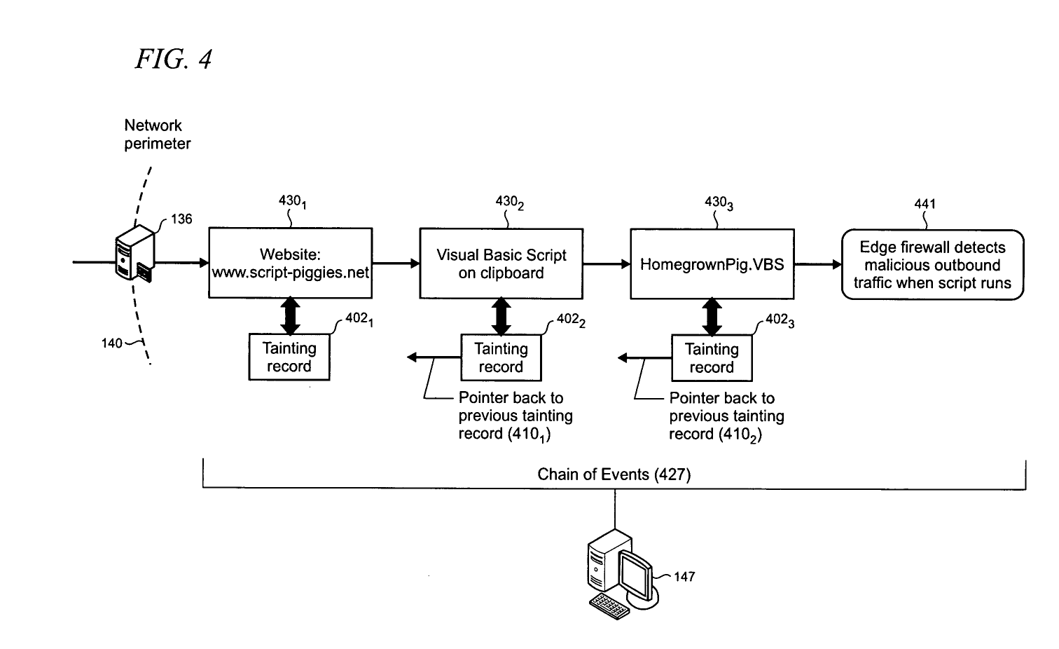

Derived data may include data that is generally related to the original data. The original data may also function as a container for the derived data, or otherwise tunnel, hide, or obfuscate the derived data. And, it is possible for additional data to be successively derived from derived data so that there can sometimes be many links in a chain of events from the original data crossing the network perimeter 140 that lead to a security compromise in the corpnet 105. Several examples of derived data are given below in the illustrative examples shown in FIGS. 3 and 4.

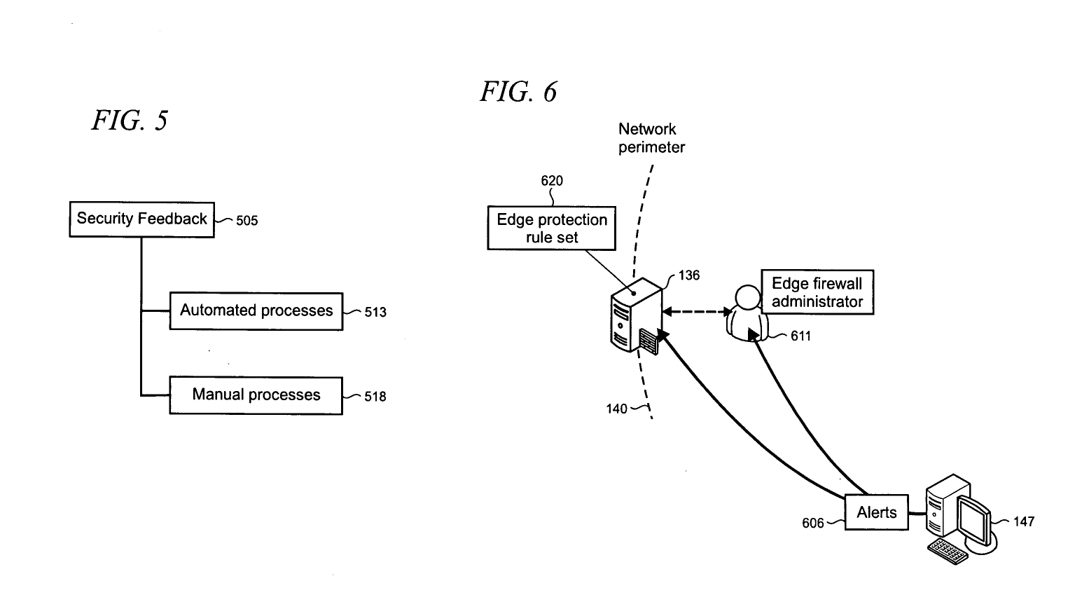

As indicated by reference numeral 223 in FIG. 2, the audit server 147 tracks and stores the tainted data 205 through the tainting records 202 to establish a chain of events 227 between the original incoming data 205 and the security compromise 217. The audit server 147 may also be utilized to collect chains of events on an enterprise-wide basis across all of the workstations 122 in the corpnet 105 in order to discover common patterns of user behavior which lead to such security compromises. The collected chains of events may then be used as feedback 230 to improve security in the corpnet 105. Security feedback is described in more detail in the text accompanying FIGS. 5-9.

FIG. 3 shows a first illustrative chain of events 327 that is tracked by the audit server 147 in the corpnet 105. A user in the corpnet 105 receives an e-mail 330 that includes an encrypted ZIP archive named PIGS-SECRET.ZIP. When the e-mail 330₁ is first received at the perimeter 140, the edge firewall 136 will not be able to scan it for any kind of malicious or forbidden content. And, since many enterprises will often allow encrypted communications with its customers, the edge firewall 136 will likely let the user read the e-mail. However, the e-mail 330₁ is tainted through use of a linked tainting record 302₁.

The e-mail 330₁ in this example includes machine-unreadable instructions on how the archive may be decrypted: “To defend from virus infection in transit, the archive is encrypted for your protection and security. Use the first four letters of the English alphabet in lowercase to extract it.” Such instructions are an example of social engineering techniques which are used to trick users into performing actions or providing information in order to further a malicious purpose.

When the user decrypts the ZIP file, the extracted file 330₂ (named dancing.pigs.jpeg.exe) is tainted as well by an attached tainting record 302₂. The tainting record 302₂ includes a pointer 310 back to the previous tainting record 302₁ which is linked to the incoming e-mail 330₁.

When the user later runs the exe file 330₂ on the workstation 122, in this example, the workstation becomes infected by a virus named NakedPig.S. The infection is detected by the desktop agent 126 as indicated by reference numeral 341. But, by tainting the incoming data crossing the corpnet perimeter 140, as well as tainting the data that is derived from it, the audit server 147 can track all the data it needs to be able to reconstruct the chain of events between the security compromise on the workstation 122 and the incoming e-mail 330.

FIG. 4 shows a second illustrative chain of events 427 that is tracked by the audit server 147 in the corpnet 105. A user in the corpnet 105 visits a website 430₁ www.script-piggies.net and copies some Visual Basic script (“VBS”) 430₂ from the website 430₁ to the clipboard functionality provided by the operating system running on the workstation 122.

The website 430₁ is tainted by linking a tainting record 402₁ to it. The clipboard contents (i.e., the VBS code) are also tainted using a linked tainting record 402₂ which includes a pointer 410₁ back to the previous tainting record that is linked to the website 430₁.

The user then follows the social engineering instructions provided by the website to save the VBS code in a file 430₃ named HomegrownPIG.VBS using the Notepad.exe utility running on the workstation 122. This file 430₃ is also tainted by a linked tainting record 402₃ which includes a pointer 410₂ back to the previous tainting record 402₂. When the user later runs the VBS file 430₃ on the workstation 122, in this example, the edge firewall 136 detects the malicious outbound traffic which results, as indicated by reference numeral 441. As with the illustrative example described in the text accompanying FIG. 3 above, the audit server 137 has the information it needs from the original incoming and derived tainted data to be able to reconstruct the chain of events between the website 430₁ and the point of the security compromise where the script generates the malicious outbound traffic.

As noted above, the chains of events that are collected across an enterprise may be used to feed security information back to other components of the corpnet 105 and to its users to improve security policies. In some cases, the chain of events may be collected in anonymized form to protect users' privacy. As shown in FIG. 5, security feedback 505 may comprise automated processes 513 and/or manual processes 518.

The automated processes 513 may include, for example, alerts 606 that are generated by the audit server 147 in an automated manner and sent to either the edge firewall 136 or an edge firewall administrator 611, as shown in FIG. 6. For example, the alerts may be generated when the number of security compromises involving ZIP files crosses a predetermined threshold. The alert 606 could be used in this case to trigger the blocking of ZIP files at the edge firewall 136, or be utilized as an input to refine or adjust the applicable edge protection rule set 620 or other security policies that may be enforced in the corpnet 105.

The manual processes 518 may involve presenting a reconstructed chain of events back to users whose actions and behaviors caused the security compromise. Such presentations can be expected to incentivize users to learn and employ more effective security practices. These may include, for example, refusing to provide the required manual operations associated with social engineering and trojans, and maintaining their workstations with the current security patches and updates.

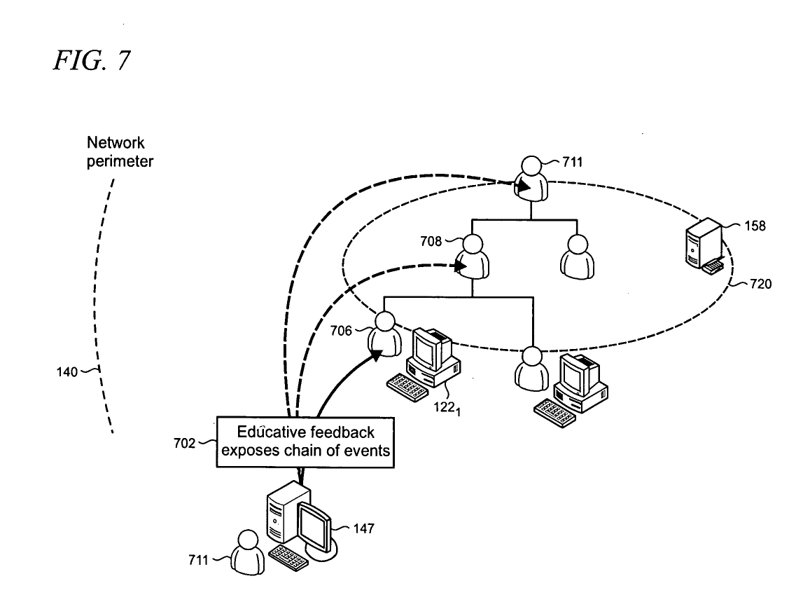

FIG. 7 shows an illustrative manual security feedback process which involves providing educative feedback 702 to a user 706 at a workstation 122₁ that is provided by an administrator 711 working, in this example, at the audit server 147 (although similar processes may also be performed at an administrator console or management server). The feedback 702 here typically will expose one or more chains of events that resulted in security compromises due to the negligent behavior of the user 706.

In some cases the feedback 702 will be sent only to the offending user 706. In other cases, for example, those involving security compromises which result in significant losses or costs being borne by the enterprise, or where the user 706 engages in repeated negligent behavior, the feedback may also be sent to supervisory personnel 708 and 711, as representatively indicated by the dashed lines in FIG. 7, as may be dictated by enterprise policy. Colleagues of the user 706 may also be notified in cases where more public exposure is believed to be helpful in educating users and/or deterring negligent behaviors. The identification of enterprise personnel and the lines of reporting/organizational hierarchy (as indicated by the dashed oval 720) may typically be determined using the directory server 158.

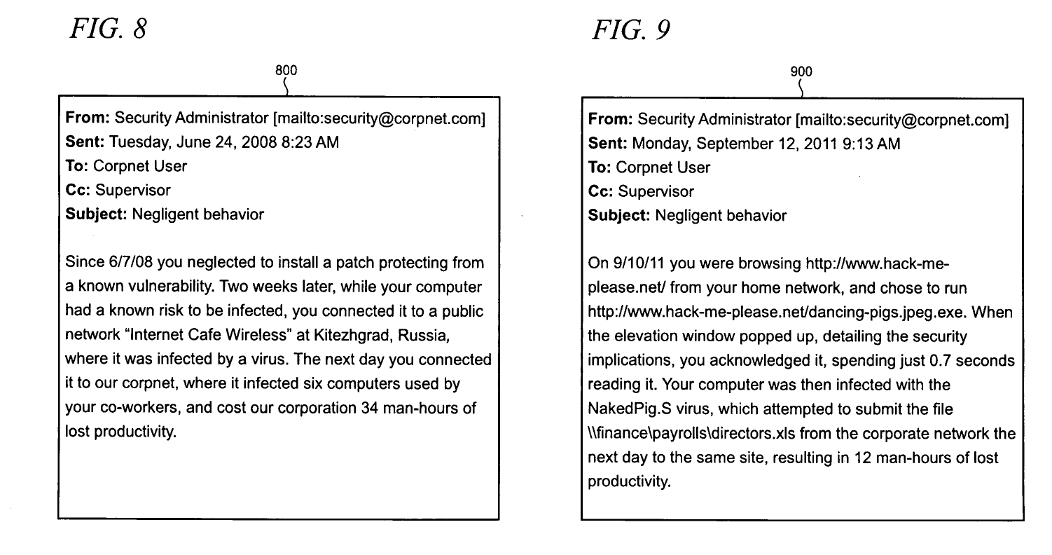

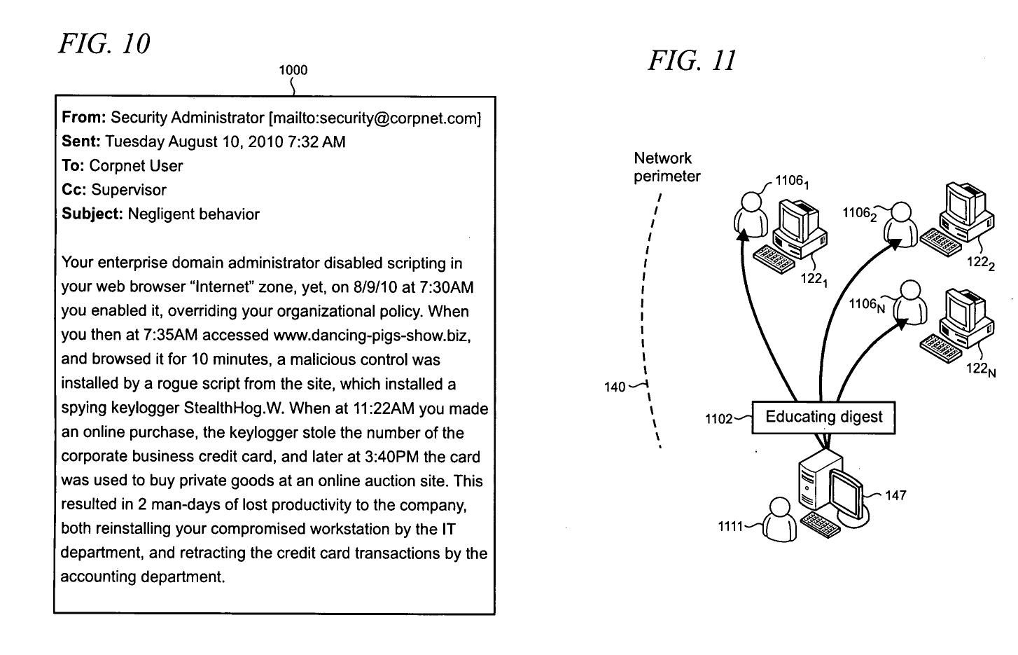

FIGS. 8, 9 and 10 show illustrative e-mail messages 800, 900, and 1000, respectively, that the administrator 711 may use to provide the educative feedback 702 and expose the chains of events to point out negligent behavior to the user. In addition, the e-mail messages outline the inhibited IT (information technology) costs that are incurred by the enterprise as a result of the security compromises. It is noted that while the administrator may manually compose the e-mail messages using the tainted data that is tracked by the audit server 147, such e-mail messages can also be composed in a semi-automated or fully automated manner in alternative implementations.

FIG. 11 shows an illustrative manual security feedback process that involves publication of an educating digest 1102 by an administrator 1111 working at the audit server 147 (or alternatively, an administrator console). The educating digest 1102 is arranged to summarize the key wrong decisions made by users in one or more chains of events that resulted in security compromises. By comparison to the feedback shown in FIG. 8 and described in the accompanying text where feedback is provided to a specifically identified negligent user, the feedback in the form of the educative digest 1102 is typically anonymized and provided to users 1106_{1, 2 . . . N} across the corpnet 105. The educating digest 1102 may help the users 1106 to identify potential security problems and social engineering traps to thus take proactive steps to avoid them in the future.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A method for utilizing a chain of events leading to a security compromise in a corpnet used in an enterprise, the method comprising the steps of:
identifying original data crossing a perimeter of the corpnet that comes from an untrusted source that is external to the corpnet;
linking a tainting record to the original data to taint the original data;
linking a second tainting record to data that is derived from the original data to taint the derived data, the second tainting record including a pointer back to the tainting record;
identifying a security compromise occurring on a workstation in the corpnet; and
reconstructing the chain of events between the original data and the security compromise on the workstation using the tainting records.

2. The method of claim 1 including a further step of linking additional tainting records to respective data that is subsequently derived from the derived data to taint the subsequently derived data, each additional tainting record being usable to taint the subsequently derived data and further including a pointer back to the previous tainting record.

3. The method of claim 2 including a further step of using the additional tainting records to reconstruct the chain of events.

4. The method of claim 3 including a further step of collecting chains of events from across the enterprise to identify common patterns of events that result in security compromises.

5. The method of claim 1 in which the original data crosses the perimeter from an external untrusted source that is accessed over the Internet.

6. The method of claim 1 in which the original data crosses the perimeter in a mobile device comprising one of portable computing device, mass storage device, or optical disc.

7. The method of claim 1 as performed by one of centralized audit server deployed in the corpnet or virtual audit server that is implemented in a distributed manner among computing platforms in the corpnet.

8. A method for utilizing feedback generated by an auditing system in a corpnet of an enterprise, the method comprising the steps of:
monitoring incoming data into the corpnet from potentially untrusted sources on the Internet;
receiving an alert from the auditing system upon reconstruction of a chain of events between the incoming data and a security compromise that is detected on a workstation in the corpnet, the chain of events being reconstructed by tracking tainting records that are respectively linked to the incoming data and data derived therefrom, each tainting record linked to the derived data including a pointer to a previous tainting record; and
filtering the incoming data responsively to the alert.

9. The method of claim 8 including a further step of modifying a rule set used for filtering the incoming data.

10. The method of claim 8 in which the detecting is performed by a desktop agent on the workstation or by a security product deployed in the corpnet.

11. The method of claim 8 including a further step of monitoring outbound traffic to detect the security compromise.

12. The method of claim 8 in which the untrusted sources include at least one of website, external storage service, or e-mail.

13. The method of claim 8 including a further step of performing caching of the incoming data to enhance a speed at which the data is served to the workstation.

14. A method for providing educative feedback regarding security compromises to users of a corpnet in an enterprise, the method comprising the steps of:
tainting data in the corpnet, the data being tainted using associated audit records, an original audit record being associated with original data that crosses a perimeter of the corpnet and subsequent audit records being respectively associated with data successively derived from the original data;
reconstructing chains of events by tracking the audit records from the original data and the successively derived data to a security compromise; and
collecting chains of events for security compromises that occur across the enterprise for presentation to users as educative feedback.

15. The method of claim 14 including a further step of configuring an audit level for the audit record.

16. The method of claim 15 in which the audit records comprise tainting records at least one of which includes a pointer to a previous tainting record.

17. The method of claim 14 in which the collecting is anonymized to protect privacy of a user whose behavior is responsible for causing the security compromise.

18. The method of claim 14 including a further step of generating an educating digest that includes key wrong decisions taken in a given chain of events that leads to the security compromise.

19. The method of claim 14 including a further step of providing the educative feedback in the form of an e-mail message that exposes a chain of events to a user whose behavior is responsible for causing the security compromise.

20. The method of claim 19 including a further step of notifying supervisory personnel of the user, the supervisory personnel being identified using a directory service deployed in the corpnet.
